(19) United States
(12) Patent Application Publication
(10) Pub. No.: US 2017/0055293 A1
(43) Pub. Date: Feb. 23, 2017

(54) Methods of Distributed Control Achieving Fair Radio Resource Access

(71) Applicant: MEDIATEK INC., Hsinchu (TW)

(72) Inventors: Weidong Yang, San Diego, CA (US); Chien-Chang Li, Penghu County (TW); Pei-Kai Liao, Nantou County (TW); Bo-Si Chen, Keelung City (TW)

(21) Appl. No.: 15/238,610

(22) Filed: Aug. 16, 2016

Related U.S. Application Data
(60) Provisional application No. 62/205,795, filed on Aug. 17, 2015.

(51) Int. Cl. H04W 74/08; H04L 12/851

(52) U.S. Cl. CPC H04W 74/0825; H04L 47/24; H04W 84/042

(57) ABSTRACT

A method of distributed control achieving fair radio resource access is proposed. The parameters used in a listen-before-talk (LBT) channel access procedure that are used to control how aggressively a node contends for channel access can be called as “Channel Access Transmission Parameters” or CAT parameters. The proposed method uses randomized CAT parameters for each traffic type, and then obtains prioritized access for some nodes at any given time and fair access averaged over a period of time. More specifically, a transmitting node can use more than one set of CAT parameters even for the same traffic type instead of conventional only use one set of CAT parameters for one traffic type. The transmitting node can use a set of CAT parameters according to a fixed schedule, a random rule, or a pseudo-random rule.

### CROSS REFERENCE TO RELATED APPLICATIONS

This application claims priority under 35 U.S.C. §119 from U.S. Provisional Application Number 62/205,795 entitled, “Method of Distributed Control Achieving Fair Radio Resource Access” filed on Aug. 17, 2015; the subject matter of which is incorporated herein by reference.

### TECHNICAL FIELD

The disclosed embodiments relate generally to wireless communication, and, more particularly, to distributed channel access control achieving fair radio resource access.

### BACKGROUND

At licensed spectrum, there is only one owner of that spectrum in an area, which facilitates to create a single depot of information for base stations (eNBs). For example, eNBs under one operator can exchange channel state information and scheduling information. With single cell scheduling, radio resource access is typically controlled by eNB in an LTE system. In Coordinated Multipoint Operation (CoMP) and eCoMP, centralized or distributed scheduling can be used to coordinate the transmissions from eNBs with a direct goal to achieve either higher SINRs or interference mitigation. A salient point about (e)CoMP is identified as information exchange is through a network link which is either proprietary or standard based (e.g. X2). Typically, the exchanged information carried over those links need to happen with latency up to tens of milliseconds.

It is seen that eCoMP can be enabled in a network wherein eNBs are provided by a single eNB vendor as the eNB vendor can design its own proprietary links among eNBs. In the case standard-defined interface exists between eNBs, for example, X2 as in eCoMP, then eNBs from different eNB vendors can also exchange information among them and mitigated interference can still be achieved. Similarly, among the schemes studied under CoMP and eCoMP, dynamic muting has been identified as an effective way to increase cell edge user throughput and average user throughput. However, without the participation of a centralized scheduler, the enhanced performance cannot be easily achieved. In summary, it is seen that interference handling is a central issue in wireless communications, and the sole ownership of spectrum at licensed spectrum has enabled information exchange among eNBs under one operator to achieve effective interference handling.

In the coming years, it is likely that unlicensed spectrum will be expanded and spectrum sharing may become a trend. From FCC's rule making, it is important to continuously improve interference handling schemes at unlicensed spectrum. However, in unlicensed band communications, the situation can be very different. As no entity, network operator or otherwise, has a monopoly of using a certain frequency spectrum in an area, there can be wireless communication equipments outside the control of an operator which interfere with that operator's equipments. Furthermore, there is no single depot where information about channel states and traffic converge. As a result, the interference handling schemes developed at licensed spectrum such as (e)CoMP, (e)ICIC, etc. may no longer work at unlicensed spectrum. Hence, there is a need to coordinate the transmissions from equipments from different vendors, or allow collaboration among equipments from different eNB vendors.

Listen-before-talk (LBT) schemes are discussed for solving the issue caused from the coexistence between WiFi and Licensed Assisted Access (LAA) and between LAA and LAA. In LAA, an established communication protocol such as LTE can be used over the licensed spectrum to provide a first communication link, and LTE can be used over the unlicensed spectrum to provide a second communication link. In LTE Release 13, LAA has been approved to enable LTE usage over unlicensed spectrum for small cells. To facilitate efficient and fair spectrum sharing, the dynamic spectrum sharing mechanism called LBT may need to be supported based on regulation rules in each country.

A fair coexistence between WiFi and LAA is often defined as if some WiFi APs/non-AP STAs are replaced with LAA eNBs/UEs, the performance of remaining WiFi APs/non-AP STAs (e.g. in terms of throughput and latency) is not degraded. However, due to the simple scheme adopted by WiFi to handle interference (e.g., CSMA/CA), WiFi's performance is not the best achievable in unlicensed bands. Various LBT mechanisms have also been proposed. However, the performance of LAA with LBT mechanism may not satisfy the purpose of efficient and fair spectrum sharing. A solution to achieve fair radio resource access is sought.

### SUMMARY

A method of distributed control achieving fair radio resource access is proposed. The parameters used in a listen-before-talk (LBT) channel access procedure that are used to control how aggressively a node contends for channel access can be called as “Channel Access Transmission Parameters” or CAT parameters. The proposed method uses randomized CAT parameters for each traffic type, and then obtains prioritized access for some nodes at any given time and fair access averaged over a period of time. More specifically, a transmitting node can use more than one set of CAT parameters even for the same traffic type instead of conventional only use one set of CAT parameters for one traffic type. The transmitting node can use a set of CAT parameters according to a fixed schedule, a random rule, or a pseudo-random rule.

In one embodiment, a wireless device obtains multiple sets of channel access transmission (CAT) parameters by a wireless device adopting a listen-before-talk (LBT) mechanism in a wireless communication network. The wireless device selects a first set of CAT parameters or a second set of CAT parameters based on a predetermined rule. The first set and the second set are associated with the same traffic category. The wireless device performs an LBT channel access procedure to contend for a wireless channel by applying the selected set of CAT parameters. The wireless device transmits radio signals if the wireless device detects a channel idle condition defined by the selected set of CAT parameters.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates an exemplary Licensed Assisted Access (LAA) wireless network that adopts listen before talk (LBT) channel access mechanism in accordance with embodiments of the current invention.

FIG. 2 illustrates an exemplary block diagram of a User Equipment (UE) and a base station (eNB) in accordance with embodiments of the current invention.

FIG. 3 illustrates a listen before talk (LBT) channel access mechanism based on initial CCA and extended CCA with distributed control in accordance with embodiments of the current invention.

FIG. 4 illustrates an exemplary diagram of multiple sets of channel access transmission (CAT) parameters in accordance with embodiments of the current invention.

FIG. 5 illustrates an exemplary diagram of energy detection (ED) thresholds and their effect on simultaneous transmissions.

FIG. 6 illustrates an exemplary diagram of randomized ED thresholds in accordance with embodiments of the current invention.

FIG. 7 is a flow chart of a method of distributed LBT channel access mechanism in accordance with embodiments of the current invention.

### DETAILED DESCRIPTION

Reference will now be made in detail to some embodiments of the invention, examples of which are illustrated in the accompanying drawings.

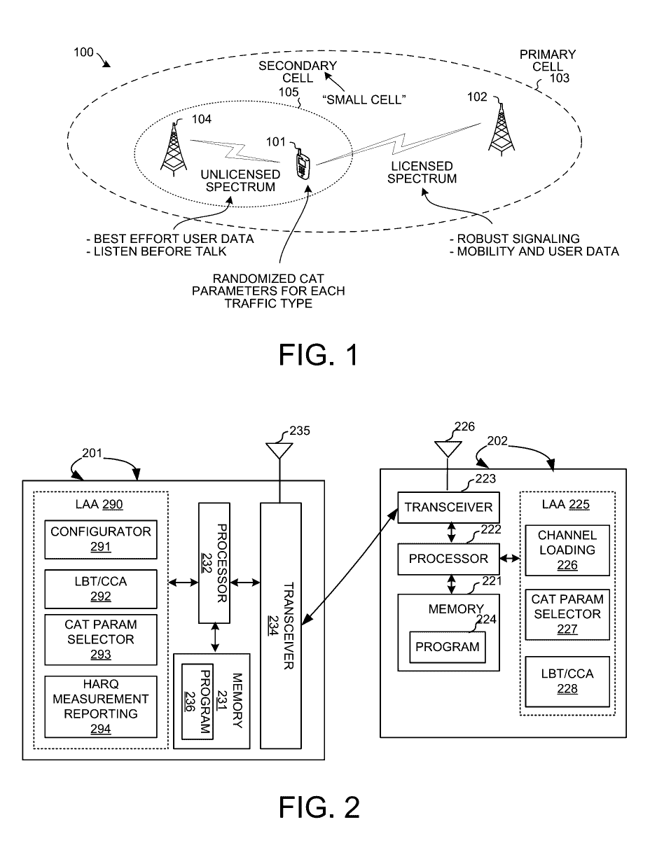

FIG. 1 illustrates an exemplary Licensed Assisted Access (LAA) wireless communications system 100 that adopts listen before talk (LBT) channel access mechanism in accordance with embodiments of the current invention. Wireless communications system 100 includes one or more wireless communication networks, and each of the wireless communication networks has base infrastructure units, such as 102 and 104. The base units may also be referred to as an access point, an access terminal, a base station, eNB, or by other terminology used in the art. Each of the base stations 102 and 104 serves a geographic area. The geographic area served by wireless communications stations 102 and 104 overlaps in this example.

Base station 102 is a licensed base station that communicates with UE 101 via a licensed frequency band. In one example, base station 102 communicates with UE 101 via Long-Term Evolution (LTE) wireless communication. Base station 102 provides wireless communication to multiple UEs within primary cell 103. Base station 104 is an unlicensed base station that communicates with UE 101 via an unlicensed frequency band. In one example, base station 104 communicates with UE 101 via LTE wireless communication. Base station 104 can communicate with multiple UEs with a secondary cell 105. Secondary cell 105 is also referred to as a “small cell”.

The exponential growth in data consumption has created large bandwidth demands that cannot be met by current wireless systems. To meet this ever-increasing demand for data, new wireless systems with greater available bandwidth are needed. Licensed Assisted Access (LAA) wireless networks can be used to provide greater available bandwidth. A LAA network utilizes licensed frequency bands in addition to unlicensed frequency bands contemporaneously, thereby provided additional available bandwidth to the UEs in the wireless system. For example, UE 101 can benefit from simultaneous use of the licensed frequency band and the unlicensed frequency band in a LAA network. The LAA network not only provides additional bandwidth for greater overall data communication, but also provide consistent data connectivity due to the presence of two separate data links. Having multiple data links available increases the probability that the UE will be able to achieve proper data communication with at least one base station at any given moment. While utilization of the unlicensed spectrum provides more available bandwidth, the use of the unlicensed spectrum faces practical problems that need to be addressed.

To facilitate efficient and fair spectrum sharing, a dynamic spectrum sharing mechanism called listen-before-talk (LBT) is supported based on regulation rules in each country. Various FBE LBT and LBE LBT mechanisms have been proposed. However, the performance of LAA with LBT mechanism may not satisfy the purpose of efficient and fair spectrum sharing. In accordance with one novel aspect, a method of distributed control achieving fair radio resource access is proposed. The parameters used in the LBT procedure which can be used to control how aggressively a node contends for channel access can be called as “Channel Access Transmission Parameters” or CAT parameters in short. As illustrated in FIG. 1, the proposed method uses the randomized CAT parameters for each traffic type, and then obtains prioritized access for some nodes at any given time and fair access averaged over a period of time. More specifically, a transmitting node can use more than one set of CAT parameters even for the same traffic type instead of conventional only use one set of CAT parameters for one traffic type. The transmitting node can use a set of CAT parameters according to a fixed schedule, a random rule, or a pseudo-random rule. The multiple sets of CAT parameters can be determined/configured for each traffic type through pre-configuration, reading system information broadcast or dedicated signaling from a network node such as an eNB or the system information broadcast in a beacon signal/channel as in WiFi.

FIG. 2 illustrates the various components included in a UE 201 and a base station 202. Base station 202 may have an antenna array 226 with one or more antennas, which transmit and receive radio signals. An RF transceiver module 223, coupled with the antenna, receives RF signals from antenna array 226, converts them to baseband signals and sends them to processor 222. RF transceiver 223 also converts received baseband signals from processor 222, converts them to RF signals, and sends out to antenna array 226. Processor 222 processes the received baseband signals and invokes different functional modules to perform features in base station 202. Memory 221 stores program instructions and data 224 to control the operations of base station 202. Base station 202 also includes a set of control modules, LAA controller 225 that carries out functional tasks to configure, schedule, execute and communicate with the UE 201 for LAA tasks such as described in detail below. In one example, LAA controller 225 includes a channel-loading calculator 226 that estimates channel loading information via eNB sensing or via HARQ ACK/NACK feedback, a CAT parameter selector 227 that determines one or multiple sets of CAT parameters for each traffic type and selects a specific set of CAT parameters at a given time based on a predetermined rule, and a LBT/CCA channel access handler 228 that ensures BS 202 only transmits radio signals over the shared medium when the channel is idle or when it wins the channel contention via LBT/CCA channel access procedure.

User equipment UE 201 has an antenna array 235 with one or more antennas, which transmit and receive radio signals. An RF transceiver module 234, coupled with the antenna, receives RF signals from antenna array 235, converts them to baseband signals and sends them to processor 232. RF transceiver 234 also converts received baseband signals from processor 232, converts them to RF signals, and sends out to antenna 235. Processor 232 processes the received baseband signals and invokes different functional modules to perform features in UE 201. Memory 231 stores program instructions and data 236 to control the operations of UE 201.

UE 201 also includes a set of control modules and circuits including LLA controller 290 that carry out functional tasks. The control modules and circuits can be implemented and configured by hardware, firmware, software, and a combination thereof. Configurator 291 obtains various configuration and parameters from the network for LBT/CCA operation. LBT/CCA channel access handler 292 ensures that UE 201 does not transmit signals when another unlicensed frequency band eNB/UE is transmitting. CAT parameter selector 293 determines one or multiple sets of CAT parameters for each traffic type and selects a specific set of CAT parameters at a given time based on a predetermined rule. Measurement and reporting circuit 294 performs Hybrid Automatic Repeat Request (HARQ) and CSI/RRM measurements and reports the HARQ feedback and measurement results to its serving base station.

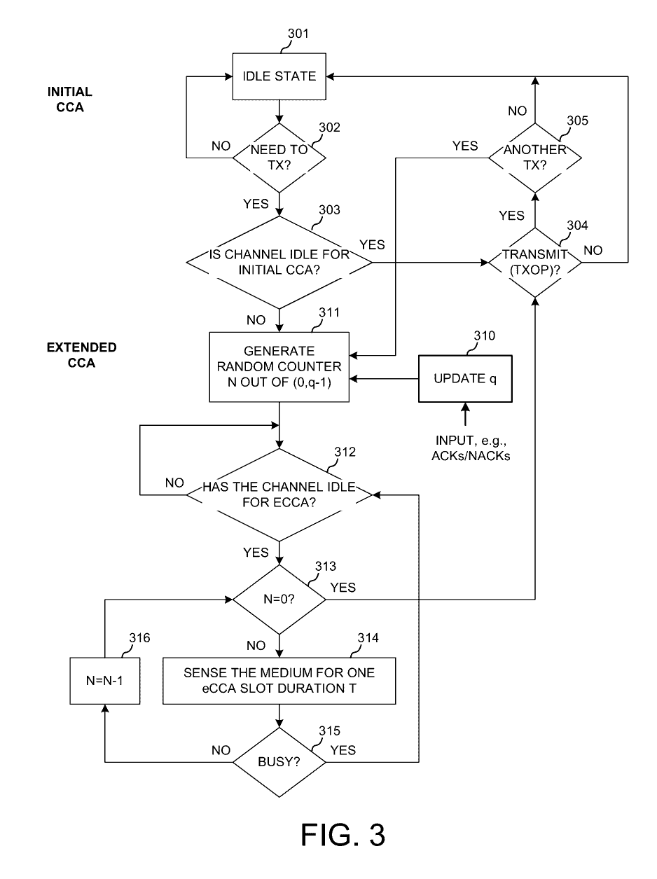

FIG. 3 illustrates a listen before talk (LBT) channel access mechanism based on initial clear channel assessment (initial CCA) and extended CCA with distributed control in accordance with embodiments of the current invention. Based on the LBT procedure, a transmitter is allowed to transmit radio signals onto the shared wireless medium depending on CCA sensing and a deferral or backoff procedure for channel access contention as long as the CCA indicates the channel is idle. The LBT procedure allows the transmitter to gain access to the shared wireless medium, e.g., to obtain a transmitting opportunity (TXOP) for transmitting radio signals onto the shared wireless medium. The basic assumption of LBT is that a packet collision can occur if a device transmits signal under the channel busy condition when the received signal level is higher than a CCA level, e.g., an energy detection (ED) threshold or a preamble detection (PD) threshold. Furthermore, LBT is a form of differentiated QoS. Traffic can be classified into four access categories (AC): AC_VI (for video), AC_VO (for voice), AC_BE (for best effort), and AC_BK (for background). Each device is expected to access the channel based on the AC-specific LBT parameters to which the traffic belongs.

In step 301, a wireless device (an eNB/UE) is in idle state. In step 302, the eNB/UE determines whether it needs to transmit. If no, it returns to idle state; if yes, it goes to step 303 and checks whether the wireless channel is idle for the initial CCA period (BiCCA, e.g., 34 us). If the answer is yes, then the eNB/UE transmits radio signals in step 304 and checks if it has obtained the transmit opportunity (TXOP). If the answer is no, then it goes back to idle state; if the answer is yes, then it goes to step 305 and determines whether it needs another transmission. If the answer is no, then it goes back to idle state.

If the answer to step 303 is no, or if the answer to step 305 is yes, then the eNB/UE goes to step 311 and enters the extended CCA procedure. In step 311, the eNB/UE generates a random backoff counter N out of the contention window size q (e.g., N is generated from 0 to q-1). In step 312, the eNB/UE checks whether the wireless channel has been idle for the extended CCA defer period (DeCCA, e.g., 34 us). If the answer is no, then it goes back to step 312; if the answer is yes, then it goes to step 313 and checks whether the random backoff counter N is equal to zero. If the answer is yes, then it goes to step 304 for transmission; if the answer is no, then it goes to step 314 and senses the wireless medium for one eCCA time slot duration T (e.g., T=9 us). In step 315, the eNB/UE checks whether the wireless channel is busy. If the answer is yes, then it goes back to step 312; if the answer is no, then it goes to step 816 and reduces the random backoff counter N by one (e.g., N=N−1), and then goes to step 313 to check whether counter N is equal to zero. Note that based on the ECCA procedure, when the channel is busy, the eNB/UE shall defer transmission until the wireless channel has been determined to be idle for an uninterrupted deferred period. One important problem in LBT is how to adapt the size of contention window. To improve efficiency of LBT, the idea of considering the historic information in the LBT mechanism has been proposed. In one example, the contention window size q is dynamically adapted based on the input of historic HARQ ACKs/NACKs.

In the LBT channel access mechanism of FIG. 3, several CCA/eCCA parameters such as the initial CCA period (BiCCA), the contention window size q, the eCCA defer period (DeCCA), and the eCCA slot duration (T) can be used to control how aggressively a node contends for channel access. This invention discloses a number of methods to divide nodes operating at an unlicensed band into groups, and by reducing the number nodes contending for radio resources, each node's transmission experiences higher SINRs than it would see if all the nodes were allowed to contend for radio resources. Further to avoid one node or one group of nodes to either suffer from persistently bad transmissions or experience unfairly high SINRs, the division of nodes into groups can change with time randomly or pseudo-randomly or with a fixed schedule. The initial CCA period (BiCCA), the contention window size q, the eCCA defer period (DeCCA), the eCCA slot duration (T), CCA ED (energy detection) threshold, CCA PD (preamble detection) threshold, eCCA ED threshold, and eCCA PD threshold are all possible knobs to turn and different setups of them can be used to divide nodes into groups. Note here the differentiation between whether CCA can be performed with energy detection or preamble detection. In the following, “CCA threshold” will be used for either CCA ED threshold or CCA PD threshold, and “eCCA threshold” for eCCA ED threshold or eCCA PD threshold.

The parameters used in the LBT procedure which can be used to control how aggressively a node contends for channel access can be called as “Channel Access Transmission parameters” or “CAT parameters” in short. The CAT parameters for category 4 LBT procedure are {BiCCA, DeCCA, T, CCA threshold, eCCA threshold}. In addition, the smaller the initial CCA period/the contention window size/the eCCA defer period/the eCCA slot duration, and the higher the CCA ED (energy detection) threshold/CCA PD (preamble detection) threshold/eCCA ED (energy detection) threshold/eCCA PD (preamble detection) threshold, a transmitting node contends for channel access more aggressively.

In accordance with a novel aspect, the preferred method uses the randomized channel access parameters even for one traffic category/type, and then obtain prioritized access for some nodes at any given time and fair access averaged over a period of time. More specifically, a transmitting node can use more than one set of CAT parameters even for the same traffic category/type instead of conventional only one set of CAT parameters for each traffic category/type. The transmitting node can use a set of CAT parameters according to a schedule, randomly, or pseudo-randomly or a fixed schedule.

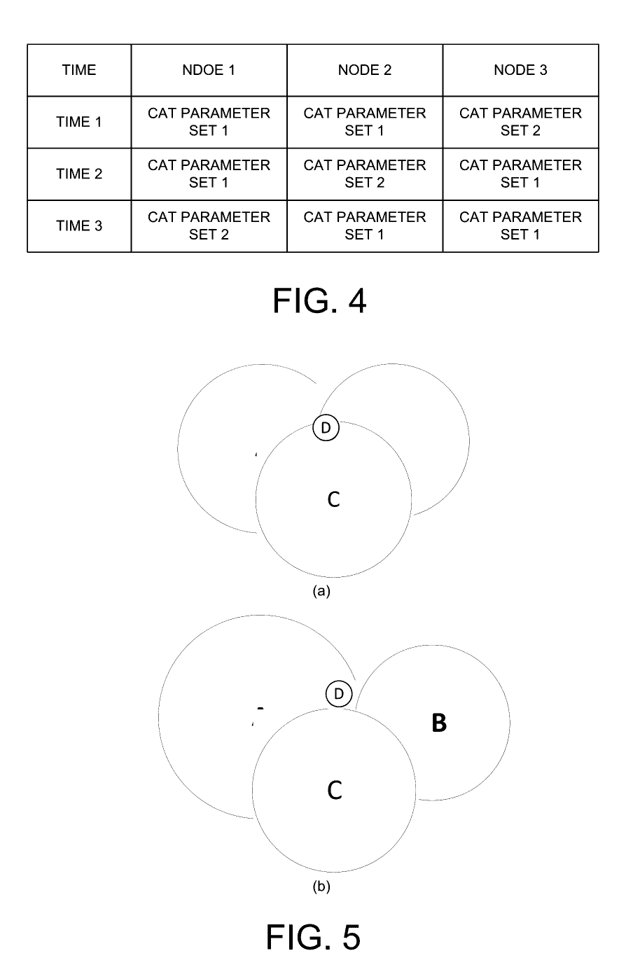

FIG. 4 illustrates an exemplary diagram of multiple sets of channel access transmission (CAT) parameters in accordance with embodiments of the current invention. Each node is given two sets of CAT parameters {BiCCA-{k,s}, DeCCA-{k,s}, T-{k,s}, CCA threshold-{k,s}, eCCA threshold-{k,s}}, where s is the index to a CAT parameter set and takes value from {1,2}, and k is the node index and takes value from {1,2,3,4,5, . . . }. For example, DeCCA-{2,5} is the defer period duration of node 5 with CAT parameter set 2. The parameters in those two sets do not have to be all different: for example for node 1, only T-{1,1} is not equal to T-{1,2}, and the rest parameters from two sets are identical. One possible way to choose those two sets CAT parameters for each node is to have one CAT parameter set which allows the node to contend for channel access aggressively and the second CAT parameter set which allows the node to contend for channel access less aggressively. When observed over a duration where multiple occasions of using the first CAT parameter set and the second CAT parameter set have occurred, each node contends for channel access with the same aggressiveness, which can be measured with channel occupancy time and other metrics. As a result, long term fairness is achieved and at the same prioritization in the short term is also achieved.

Switching among the CAT parameter sets can be conducted in a number of ways. In a first example, at a node, the CAT parameter set used at a time is according to a fixed schedule: CAT parameter set 1, CAT parameter set 1, CAT parameter set 1, CAT parameter set 2, CAT parameter set 2, CAT parameter set 2, CAT parameter set 1, CAT parameter set 1, CAT parameter set 1 . . . and so on so forth. In a second example, at a node, the CAT parameter set used at a time is chosen randomly. Each CAT parameter set can be assigned a probability, and their probabilities are not necessarily the same. For example, 0.5, 0.3 and 0.2 can be assigned to 3 CAT parameter sets; and alternatively 0.8, 0.1 and 0.1 can be assigned those 3 CAT parameter sets too. Yet the second assignment may result in a different aggressiveness in the node compared to the first assignment. Further, the assigned probability can also be used as a tool to control how aggressively a node contends for channel access. At each time that LBT needs to be performed, the node randomly choose one CAT parameter set according to the assigned probabilities. In a third example, at each time that LBT needs to be performed, the choice of the CAT parameter set is controlled in a pseudo-random fashion. For example, a pseudo-random number generator can output an index and the index is used to select the CAT parameter set. The random seed for the pseudo-random number generator can include UE ID, eNB/cell ID, operator ID or some value signaled by eNB.

In the example of FIG. 4, the assumption is taken as the LBT procedure with CAT parameter set 1 is more aggressive than the LBT procedure with CAT parameter set 2, and three time epochs are used as examples. At Time 1, Node 1 and Node 2 use CAT parameter set 1, and Node 3 uses CAT parameter set 2; node 3 has a less chance than nodes 1 and 2 to grab the channel. If node 2 and node 3 start transmissions simultaneously, the SINRs at their respective receiving nodes (e.g. UEs) are higher than in the case that nodes 1, 2 and 3 transmit simultaneously. At Time 2, node 2 has a less chance than nodes 1 and 3. At Time 3, node 1 has a less chance than nodes 2 and 3. When a single CAT parameter set is used for all nodes at all time, as the time durations (BiCCA, DeCCA, T) are the same for all of them, it can happen that two nodes following the LBT procedure can decide to start transmissions at the same time (e.g. two nodes wait for the same BiCCA, and decide to transmit). When different time durations are used for different nodes, then the simultaneous transmissions from nodes become less likely as the transmission from node will inhibit the transmission from other nodes. In the example of FIG. 4, by taking turn to be polite (i.e. muting its transmission), each node actually can enjoy a higher throughput than in the case everyone aggressively contends for every transmission opportunity.

FIG. 5 illustrates an exemplary diagram of energy detection (ED) thresholds and their effect on simultaneous transmissions. As depicted in FIG. 5, the circles around nodes A, B, and C are shown to overlap with node D, and the radius of each circle indicates the ED threshold: the lower the ED threshold, the larger the radius. In FIG. 5(a), when the same ED threshold is used for nodes A, B, and C, if the ED threshold is high, then transmission at node D will not inhibit the transmission from node A, B, or C. As a consequence, each recipient for node A, B, or C's transmission will experience interference from other two nodes in addition to node D. If the ED threshold is low, then nodes A, B, and C will be inhibited from transmission simultaneously. Yet with a low ED threshold it may happen nodes A, B and C are all inhibited from transmission while no one gets a chance to use available spectrum.

In FIG. 5(b), node A uses a lower ED threshold as compared to nodes B and C. The transmission from node D inhibits the transmission from node A, not the transmission from node B and C. As a consequence, the recipient for node B or C does not suffer from interference from node A, and it benefits from improved SINR. At another time, nodes A and C may use the same high ED threshold, but node B uses a lower ED threshold, then the recipient for node A or C benefits from the improved SINR.

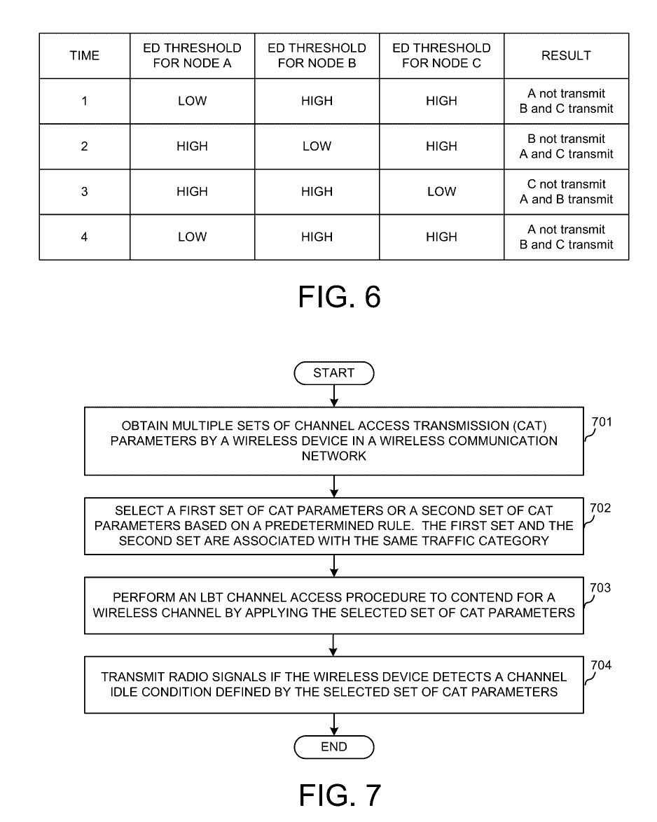

FIG. 6 illustrates an exemplary diagram of randomized ED thresholds in accordance with embodiments of the current invention. At Time 1, Nodes B and C use high ED threshold while Node A uses low ED threshold, and the recipient for node B or C benefits from improved SINR. At Time 2, Nodes A and C use high ED threshold while Node B uses low ED threshold, and the recipient for node A or C benefits from improved SINR. At Time 3, Nodes A and B use high ED threshold while Node C uses low ED threshold, and the recipient for node A or B benefits from improved SINR. At Time 4, Nodes B and C use high ED threshold while Node A uses low ED threshold, and the recipient for node B or C benefits from improved SINR. By taking turn to be polite, each node actually can enjoy a higher throughput than in the case everyone aggressively contends for every transmission opportunity.

FIG. 7 is a flow chart of a method of distributed LBT channel access mechanism in accordance with embodiments of the current invention. In step 701, a wireless device obtains multiple sets of channel access transmission (CAT) parameters by a wireless device in a wireless communication network. In step 702, the wireless device selects a first set of CAT parameters or a second set of CAT parameters based on a predetermined rule. The first set and the second set are associated with the same traffic category. In step 703, the wireless device performs an LBT channel access procedure to contend for a wireless channel by applying the selected set of CAT parameters. In step 704, the wireless device transmits radio signals if the wireless device detects a channel idle condition defined by the selected set of CAT parameters.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
obtaining multiple sets of channel access transmission (CAT) parameters by a wireless device in a wireless communication network;
selecting a first set of CAT parameters or a second set of CAT parameters based on a predetermined rule, wherein the first set and the second set are associated with the same traffic category;
performing a channel access procedure to contend for a wireless channel by applying the selected set of CAT parameters; and
transmitting radio signals if the wireless device detects a channel idle condition defined by the selected set of CAT parameters.

2. The method of claim 1, wherein the channel access procedure adopts a listen-before-talk (LBT) mechanism involving clear channel assessment (CCA) sensing, and wherein each set of CAT parameters corresponds to a set of CCA parameters.

3. The method of claim 1, wherein the first set of CAT parameters allows the wireless device to contend for the wireless channel more aggressively than the second set of CAT parameters.

4. The method of claim 3, wherein a CCA level of the first set of CAT parameters is higher than a CCA level of the second set of CAT parameters.

5. The method of claim 4, wherein the CCA level indicates a preamble detection threshold.

6. The method of claim 4, wherein the CCA level indicates an energy detection threshold.

7. The method of claim 1, wherein the predetermined rule is based on a fixed time schedule.

8. The method of claim 1, wherein the predetermined rule is based on a randomized time schedule.

9. The method of claim 1, wherein the predetermined rule is based on a pseudo random rule.

10. The method of claim 1, wherein the wireless device belongs to a group of wireless devices that apply the same set of CAT parameters at a given time.

11. A wireless device, comprising:
a configurator that obtains multiple sets of channel access transmission (CAT) parameters by a wireless device in a wireless communication network;
a CAT parameter selector that selects a first set of CAT parameters or a second set of CAT parameters based on a predetermined rule, wherein the first set and the second set are associated with the same traffic category;
a channel-access handler that performs an LBT channel access procedure to contend for a wireless channel by applying the selected set of CAT parameters; and
a transmitter that transmits radio signals if the wireless device detects a channel idle condition defined by the selected set of CAT parameters.

12. The wireless device of claim 11, wherein the channel access procedure adopts a listen-before-talk (LBT) mechanism involving clear channel assessment (CCA) sensing, and wherein each set of CAT parameters corresponds to a set of CCA parameters.

13. The wireless device of claim 11, wherein the first set of CAT parameters allows the wireless device to contend for the wireless channel more aggressively than the second set of CAT parameters.

14. The wireless device of claim 13, wherein a CCA level of the first set of CAT parameters is higher than a CCA level of the second set of CAT parameters.

15. The wireless device of claim 14, wherein the CCA level indicates a preamble detection threshold.

16. The wireless device of claim 14, wherein the CCA level indicates an energy detection threshold.

17. The wireless device of claim 11, wherein the predetermined rule is based on a fixed time schedule.

18. The wireless device of claim 11, wherein the predetermined rule is based on a randomized time schedule.

19. The wireless device of claim 11, wherein the predetermined rule is based on a pseudo random rule.

20. The wireless device of claim 11, wherein the wireless device belongs to a group of wireless devices that apply the same set of CAT parameters at a given time.
